(19) United States
(12) Patent Application Publication
(10) Pub. No.: US 2026/0095307 A1
(43) Pub. Date: Apr. 2, 2026

(54) Device Distributed Blockchain - 2DB

(71) Applicants: Azhar Hussain, Maia (PT); Matthew Travers, London (GB); Simone Flori, London (GB)

(72) Inventors: Azhar Hussain, Maia (PT); Matthew Travers, London (GB); Simone Flori, London (GB)

(21) Appl. No.: 19/323,331

(22) Filed: Sep. 9, 2025

Related U.S. Application Data
(60) Provisional application No. 63/692,251, filed on Sep. 9, 2024.

(51) Int. Cl. H04L 9/08; H04L 9/00; H04L 9/32

(52) U.S. Cl. CPC H04L 9/0825; H04L 9/0861; H04L 9/3247; H04L 9/50

(57) ABSTRACT

This invention relates to an improved method and system for authenticating the travel path of an object using a distributed asynchronous system incorporating blockchain technology and encrypted codes. The system utilizes digitally secured tags containing encrypted logistical data. These tags are physically and digitally associated with the product prior to entering the supply chain. Gateways equipped with artificial intelligence are strategically placed throughout the transportation route, each gateway receiving inputs from any number and type of sensors placed throughout the gateway's physical location. These gateways continuously collect data from their environment and utilize artificial intelligence to create dynamic environmental profiles. These profiles, encapsulated within a cryptographic key, are immutably recorded onto the blockchain ledger associated with the tag device physically associated to a shipment. The distinctive feature of this innovation assures an unalterable record of each shipment's journey, enhancing security, promoting transparency, and enabling swift transmission—and verification—of shipment data.

### BACKGROUND OF THE INVENTION

Current supply chain chain-of-custody issues are primarily driven by a lack of transparency and an increasing risk of fraud and cyberattacks in global supply networks. In contrast to the clear ownership history in real estate, supply chains often have disjointed and incomplete digital records that are held across different data silos, making it difficult to verify the provenance and ethical sourcing of goods through a common index. A primary root cause of chain-of-custody problems is the limited visibility that many companies have into their supply chains. Modern global supply chains are a complex web of numerous partners, including material suppliers, manufacturers, logistics providers, and distributors. Many companies lack visibility beyond their internal systems and extended immediate suppliers and customers. This poor visibility creates opportunities for fraud, theft, process failures and security breaches. Products can be tampered with or replaced with counterfeit components at various points in the supply chain. Without a secure and transparent log of custody transfers, it is easy for products to be stolen or redirected. The logistics industry is particularly vulnerable to cargo theft, tax evasion, smuggling contraband and other criminal activities. Financial fraud can occur when unscrupulous vendors submit falsified or inflated invoices, which can be difficult to detect when record keeping is poor and the chain of approval is opaque. And as supply chains increasingly rely on software applications, there is an increased risk of cyberattacks which can affect the integrity of tracking data. The vulnerabilities in the supply chain often, but not exclusively, rely on creating a false providence of the goods and using that as a means of injecting and blending in false or unauthorized products into legitimate supply.

There are also ethical sourcing and compliance issues stemming from the inability to have a clear, secure chain of custody in the supply chain. Shareholders and regulators increasingly demand greater transparency regarding the environmental, social, and governance practices within a company's supply chain. Missing links in the chain of custody make it nearly impossible to prove and verify sustainable sourcing or ethical practices. Companies are also being held more legally and socially accountable for the actions of their partners, meaning that a failure to take active steps to prevent fraud or monitor ethical standards and ensure regulatory compliance can lead to significant legal and financial consequences.

Companies also have a significant interest in ensuring that their products are sold only by approved retailers received through authorized channels. Companies and consumers are harmed when goods are redirected into the “gray market” where authentic products are sold through unauthorized channels. Current logistics supply chain systems lack a global data recording mechanism suitable for legal and commercial environments which can simultaneously ensure the integrity and authenticity of the data. While current systems are concerned with the security of the shipment, they are focused on physical security such as locks and location tracking via global positioning data. Authorized goods often become entangled in the gray market when distribution channels are undermined or circumvented. For instance, when wholesalers or retailers divert products intended for one market to another, bypassing established pricing structures and regional exclusivity, these originally genuine items become part of the gray market. This unauthorized redirection not only erodes brand integrity and expected revenue streams but also compromises warranty provisions and support services that accompany legitimately distributed products. As such, the proliferation of gray market goods can dilute brand reputation, creating a parallel economy where authentic products are sold outside of the sanctioned supply network. Gray market activity is especially common in electronics, fashion, beauty, pharmaceuticals, and luxury goods—industries with large price gaps across countries, where demand is strong and resale is profitable. These industries also involve items that travel easily—high-value products in small packages. The challenge is further complicated with the introduction of counterfeit goods that can cause harm to consumers and, in some cases, death.

Current systems and operations are dependent on synchronous activities between the elements to complete the transaction and capture events. This creates operational friction and dependencies in a live real-world operation. The data transfer from a sensing device to the end user is usually done between the tracking device and a back-end server as a whole piece of information, this is how, on a high level, the Internet of Things (IoT) supply chain tracking works now. The current field does not allow for proof of transportation of items to be captured as part of a chain of custody, nor does it provide for document and transportation data to be captured and recorded in real time without large network and storage dependencies. Current systems and operations further do not provide the opportunity for unique identifier data points to be appended to shipping histories that would authenticate each point on the path of travel of a shipment using unique and encrypted identifiers. These supply chain inefficiencies present myriad opportunities for products to leak into the gray market and counterfeit economies. Paperwork is used to certify the authenticity of the shipment, but this is open to forgery and is the main vector of attack by bad actors and poor user training and implementation.

Serial numbers and Radio Frequency (RF) tags are commonly used methods for tracking and authenticating goods throughout the supply chain; however, while they serve as basic tools for inventory management and anti-counterfeiting measures, they possess several limitations that do not fully prevent the diversion of authorized goods into the gray market. Firstly, serial numbers, while unique, can be replicated or removed by unauthorized entities seeking to disguise the product's true origin. If the serial numbers are generated and verified through algorithms, then once the algorithm is reverse engineered, its protection instantly ceases for all applied things with no ability to authenticate providence. The visibility of serial numbers also makes them vulnerable to tampering, potentially allowing gray marketeers to re-label products and thus obscure their provenance. Furthermore, the reliance on databases to verify serial numbers can be compromised through cyber-attacks or insider collusion, leaving a blind spot in the authentication process. The central database also requires all supply chain participants to be on the same system and be trusted to update the information with a consistency and reliability that is not always managed during the update process. Failures are discovered during investigations after the harm has already occurred. Secondly, RF tags, which utilize radio waves to transmit data from a tag attached to an item to a reader, can similarly be manipulated or cloned. Despite their ability to store a wealth of information about a product, RF tags' security protocols can still be breached by sophisticated counterfeiters who have the technical acumen to copy or alter the information contained within the tags without it being detected. Moreover, once products with RF tags are outside of controlled supply chain environments, such as retail outlets or warehouses enabled with readers designed to detect these tags, their tracking becomes significantly more difficult—enabling unauthorized distribution channels to flourish without detection.

In summary, while serial numbers and RF tags provide a measure of control within certain parameters of the distribution process, they fall short in creating a foolproof system capable of preventing all incidences of legitimate goods leaking into the gray market and counterfeit goods infiltration. More advanced and secure technologies need to be incorporated within a multi-layered approach to truly mitigate this pervasive issue and safeguard both brands and consumers from the risks associated with unauthorized distribution.

Blockchain technology is a transformative innovation that establishes unalterable and transparent data records through its decentralized ledger system. Each block within the blockchain contains a unique cryptographic hash, which not only secures the information but also establishes an indelible link to the preceding block, thus providing a tamper-resistant chain of transactional data. However, the very process that ensures this impressive security—the repeated proof-of-work (PoW) required for consensus on each transaction—consumes considerable amounts of electrical energy and mandates extensive storage capacity to maintain the ever-growing chain of blocks. This characteristic has historically posed challenges in terms of economic viability, as well as operational sustainability and efficiency, especially as blockchain networks scale up to accommodate an expanding volume of transactions.

Current blockchain implementations are not suited for supply chain applications where there is a diverse set of participants involved in the same transaction. Blockchain is optimized for single level trust between the two directly connected parties whereas supply chains require securing multi-level trust along the chain so that parties can trust not only their direct connection, but parties beyond them as well. Supply chain actors are not always on the same connected system and cannot be relied upon to have a persistent network connection, which are fundamental requirements for current blockchain operation. Supply chain actors are not commercially aligned to invest in the crypto fuel required to power the PoW validation in traditional blockchain application. Current blockchain technology is also not efficient enough to handle the supply chain transaction volumes on a global level in a timely manner. The blockchain architecture is a bottleneck with several dependencies across different systems to process a transaction. The size of the blocks is limiting for the volume of supply chain objects that need to be tracked globally. This increases the PoW cost and slows performance as increasingly more blocks are added to the chain. Storage costs for current blockchains are also prohibitive at scale. There is a need to lower the costs, driving the adoption of a blockchain distributed ledgers system concept to the supply chain logistics market. This requires a new architecture for the blockchain framework to be effective within the supply chain. The full benefits of a distributed ledger can't be effectively realized within the current blockchain framework that works for applications such as financial transactions where maintaining and validating transactions benefits all stakeholders current and future. That is not the case for supply chain applications where the actors come together for specific transactions and where their commitments fall away on different timelines based on their position in the supply chain and their corresponding regulatory obligations. This means that whilst the costs of the traditional blockchain falls on all users, not all users benefit equally. There exists a need for a distributed ledger technology that differs from traditional blockchain systems.

Furthermore, current distributed ledger implementations related to authentication of the item in transit and not authenticating the locations through which the item travels en route to its destination. This still allows opportunities for both counterfeit goods to be injected and blended into the supply chain, and for authentic goods to be routed to unauthorized retailers. Current implementations do not provide enough safeguards against black market and gray market economies.

### SUMMARY OF THE INVENTION

It is an object of the present invention to provide an improved way of effectively recognizing, creating a log of, and authenticating the travel path of a physical object.

A solution to this problem is provided by the teaching of the appended independent claims. Various preferred embodiments of the present invention are provided by the teachings of the dependent claims.

Furthermore, an entire travel path authentication solution is presented herein, including a method and a system for location recognition, a method of training such system, and devices for the identification, authentication, and recording of one or more physical location data points and related methods and corresponding computer programs as different aspects that may form part of an overall multi-component travel path authentication solution for effectively and efficiently protecting the integrity of a supply chain.

A first aspect of the travel path authentication solution is directed to a method for authenticating travel paths of objects. This authentication method comprises several novel steps, implemented via a combination of hardware and software components, that serve to identify and verify a point on a path of travel with a high degree of accuracy and reliability. At the outset, the authentication method entails acquiring spatial-temporal data from one or more sensor devices located throughout a location. These devices can include, without limitation, wifi sensors, HD/FM metadata sensors, GPS location sensors, temperature sensors, humidity sensors, light sensors, pressure sensors, motions sensors, humidity sensors, IP number sensors, inertial measurement units (IMUs), and other suitable sensors capable of contributing data points for the generation of a completely unique and very precise location-identifying fingerprint.

Upon collection, the spatial-temporal data undergoes processing by means of a machine-learning-based location recognition process within a gateway unit at the location or by a remote server in communication with the gateway unit through a secure channel to obtain discriminating data representing the precise environment of the location and generating a cryptographic key.

The processor executes algorithms designed for real-time analysis of the spatial-temporal data to ascertain the location's precise conditions and compare it against one or more master data repositories with restricted access which contain the cryptographic key data for each location. This creates defined parameters within which an item's presence is considered valid for the particular transactions or activities. Furthermore, historical location information is taken into account by comparing current location data with previously recorded patterns to detect anomalies or support recurring behavior as part of the authentication process. Machine learning techniques can be employed to enhance the predictive capability and adaptive response of the ALR method over time.

The term “spatial-temporal data”, as used herein, refers to data describing or otherwise representing the qualities of a specific physical location at a specific time, including by one or more discriminating characteristics thereof. Herein, the term “discriminating characteristics” refers to at lease one characteristic property of the physical location, which is suitable for distinguishing the physical location from other physical locations.

The term “authentication” as used herein refers to confirming the truth of attributes of a physical location based on data collected and processed from the physical location.

The term “gateway device” as used herein refers to a device which continuously collects spatial-temporal data from sensors located in its physical location, which uses artificial intelligence to create a profile of the physical location, and which generates a hash code based on the inputs from said sensors.

The term “tag device” as used herein refers to an item capable of receiving hash code information from a gateway device and storing one or more hash codes on a digital ledger.

The term “machine-learning based location recognition process” as used herein refers to a process where one or more computers are employed to recognize a location based on input data from various sensors and with the help of one or more machine-learning-based algorithms. Machine learning is an application of artificial intelligence (AI) that endows systems with the capability to automatically learn and improve from experience without being explicitly programmed. It focuses on the development of computer programs that can access data and use it to learn for themselves. The core principle of machine learning is to give computers the ability to learn from and make predictions or decisions based on data. This learning process begins with observations or data in order to look for patterns in data and make better decisions in the future based on the examples provided.

Different types of machine learning approaches include, without limitation, (i) supervised learning, wherein the computer is presented with example inputs and their desired outputs, given by a supervisor, and the goal is to learn a general rule that maps inputs to outputs; (ii) unsupervised wherein no the system tries to find the structure in the input data on its own, and (iii) reinforcement learning, wherein a computer interacts with a dynamic environment in which it must perform a certain goal, and it is rewarded or penalized through feedback in order to learn optimal strategies.

The term “secure virtual representation” of a physical location, as used herein, refers to a data representation thereof, which is defined such that it is nearly impossible to find two different physical locations such that their respective data representations are indistinguishable.

The term “cryptographic hash function” as used herein refers to an algorithm that takes an input and returns a fixed-size string of bytes, typically a digest that appears random. The output is typically a fixed-size string of characters that may appear random but is consistent for the same input. The output is commonly known as the hash value or hash code. A key feature of such hash function includes the “avalanche” effect, whereby changing even a single bit of the input should produce an entirely different hash that has no apparent relation to the original hash, making it impossible to predict what the original data was. Hence, it should be computationally infeasible to find two different sets of inputs that produce the same output hash value. Cryptographic hash functions are commonly used for various security applications, such as checking data integrity, securing password storage, creating digital signatures, and facilitating various cryptographic protocols and systems. Some well-known cryptographic hash functions include the SHA-2 family which includes SHA-256 and SHA-512, and the BLAKE family which includes BLAKE2. In particular, so-called “provably secure cryptographic hash functions” may be used.

The term “digital signature” as used herein refers to using a set of one or more digital values that confirms the identity of a sender or originator of digital data. To create a digital signature, a hash value is generated from the data to be protected by way of application of a cryptographic hash function. This has value is then encrypted with a private key (an “RKEY” as used herein) of an asymmetric cryptographic system, wherein the RKEY is typically known only to the sender/originator. Usually, the digital signature comprises the digital data itself as well as the hash value derived from it by the sender/originator. A recipient may then apply the same cryptographic hash function to the received digital data, use the public key corresponding to said private key to decrypt the hash value comprised in the digital signature, and compare the decrypted hash value from the digital signature with the hash value generated by applying the cryptographic hash function to the received digital data. If both hash values match, this indicates that the digital information has not been modified and thus its integrity has not been compromised. Furthermore, the authenticity of the sender/originator of the digital data is confirmed by way of the asymmetric cryptographic system, which ensures that the encryption using the public key only works, if the encrypted information was encrypted with the private key being mathematically paired to that public key. The representation of the digital signature may be implemented using an RFID transmitted or a single- or multi-dimensional barcode, such as a QR-code or even a multi-digit number.

The term “master repository”, as used herein, refers to a data storage, such as a database, where the data stored therein can only be accessed upon prior authorization, particularly authentication of the entity or person attempting the access. Without limitation, such restricted access may be implemented by means of password protection or multi-factor authentication.

This method of authenticating an object's travel path defines one of several aspects of an overall travel path authentication solution. Within the overall solution, it serves to authenticate the travel path of an item based on a gateway device collecting spatial-temporal data from sensors at at least one point along the travel path and by means of a machine-learning physical location profile recognition process being applied thereto, using the device to append a hash code reflecting the physical location of the gateway device to the ledger of every tag that enters the physical location of and digitally interacts with the gateway device, and comparing the ledger of hash codes at the object's destination to a master repository of hash codes and profiles for each gateway device the object has interacted with from point of origin to its destination.

A second aspect of the travel path authentication solution is directed to a method of training a system for automatic physical location recognition. The method comprises (i) receiving spatial-temporal data representing one or more discriminating characteristics of a physical location; (ii) processing the physical location data by means of a machine-learning-based physical location recognition process to obtain discriminating data representing a secure virtual representation of the physical location; and (iii) storing reference data comprising the discriminating data and a hash code derived therefrom by application of a predetermined cryptographic hash function thereto into one or more master repositories with restricted access.

This method of training a system for automatic physical location recognition defines another aspect of said overall travel path authentication solution. Within the overall solution, it serves to generate and store the reference data and thus to prepare and enable a system to perform the method of the first aspect in the course of authenticating a physical location.

In the following, selected embodiments of this method of training a system are described, which may be arbitrarily combined with each other or with other aspects of the solution described herein, unless such combination is explicitly excluded, inconsistent, or technically impossible.

In some embodiments, storing the reference data comprises storing the discriminating data into a first one of the data repositories and storing identification data into a separate second data repository such that neither the first nor the second data repository stores both the discriminating data and the corresponding hash code values for any location on the travel path. This separation allows for storing the discriminating data and the corresponding hash code in different spatial locations, enabling distributed computing and distributed data storage.

In some embodiments, processing the physical location data to obtain discriminating data comprises generating, by means of performing one or more predefined modification operations, a plurality of secure virtual representations of said physical location, such that at least two of these virtual representations represent the same physical location but each at a different condition. Specifically, in some embodiments thereof, said different conditions relate to one or more of the following: (i) different times of year at the physical location; (ii) different times of day at the physical location; (iii) an increase in digital signals at the physical location; (iv) different air pressure at the physical location; (v) different humidity at the physical location; and/or (vi) different light conditions at the physical location. These different condition points per location may be used to create respective virtual representations of the physical location to improve recognition and patterns of the physical location to increase the reliability of the physical location recognition.

In some embodiments, storing the reference data comprises one or more of the following: (i) storing the reference data in a digitally signed form into at least one of said master repositories; (ii) storing or causing one or more nodes of a blockchain environment to store the hash codes in a digitally signed form into a block of a blockchain related to said blockchain environment; (iii) storing or causing one or more nodes of a blockchain distributed ledger environment to store the hash codes in a digitally signed form into at least one node of said blockchain distributed ledger environment. The digital signing serves as a protection measure based on which the integrity of the stored data can be verified. The same applies particularly when the stored data is retrieved and communicated over a communication link, e.g. to a tag device as described herein.

Storing the hash codes in a blockchain distributed ledger enables a secure, reliable storage of the reading results with very high data integrity, such that it is essentially impossible to manipulate or erase or otherwise tamper with or lose the data, due to unintended or deliberate action. Thus, the complete storage history remains available. Furthermore, the stored information can be accessed wherever access to the blockchain distributed ledger is available. This allows for a safe and distributed storage and access to the store authentication data. Based on one or more of these embodiments, the blockchain can be used to generate a secure and authenticated path of travel for objects in the supply chain in a zero-trust environment. The system and method described herein allow for completely anonymous verification of the travel path of objects in the supply chain without requiring human input and without relying on information provided by any human or entity in the supply chain.

A third aspect of the present solution is directed to a system for automatic travel path authentication, the system being configured to perform the method of one or more of the first and second aspects of the present invention.

A fourth aspect of the present solution is directed to a computer program comprising instructions, which when executed on one or more processors of a system for automatic travel path authentication according to the third aspect causes the system to perform the method according to any one or both of the first and second aspects of the present solution.

Accordingly, as the explanations provided above with respect to these methods apply mutatis mutandis to the system according to the third aspect and the computer program according to the fourth aspect of the present solution.

It should be appreciated that this automatic location recognition is fundamental to confirming supply chain integrity by correlating the physical conditions of a location with digital transactions or activity initiations. The foregoing description encapsulates the methodological framework and operational principles underlying this first aspect, wherein its embodiment is not limited to any specific apparatus configuration or technological implementation but rather encompasses all variations that fall within the scope of the appended claims.

### BRIEF DESCRIPTION OF DRAWINGS

Further advantages, features and applications of the present travel path authentication solution are provided in the following detailed description and the appended figures, wherein:

FIG. 1 illustrates a communication sequence diagram of the travel path authentication system involving a server, tag device, and gateway. The process begins with the gateway broadcasting a connection availability. The tag device responds by sending a connection request, which is then accepted. Subsequently, the tag device requests the previous event ID and sends the event ID. The gateway receives raw data including ID, device ID, timestamp, location, and previous event ID, acknowledging this data transfer. The gateway then generates an RKEY, which is sent back to the tag device, followed by an acknowledgment of the RKEY transfer. This cycle continues with subsequent transmissions of raw data and RKEY data;

FIG. 2 illustrates a sequential data storage and transmission system involving multiple gateways as part of a travel path authentication solution. The system tracks the movement of devices through various locations over time. Each gateway processes and forwards data packets that include a device identifier, a timestamp, location coordinates, and an encoded cryptographic key (RKEY). The table shows how raw data and RKEYs are transferred through these gateways, with each entry connected by a previous ID to maintain the sequence. The data portrays the connectivity and fluid transition from one location to another, demonstrating the integrity and reliability in tracking the travel path using spatio-temporal data in a secure manner.

FIG. 3 illustrates one embodiment of a tag device in which the collected ledger data and the identity of the tag device are accessed via a QR code and bar code, respectively.

FIG. 4 depicts one embodiment in which the tag device is associated with or linked to a group of identifiers which are attached to individual items within the shipment on which the tag device is placed to verify the integrity of the travel path for items within the shipment as well as the shipment as a whole.

FIG. 5 depicts a box to be shipped with a tag device attached to the box, prepared to receive data from gateways along the travel path of the box.

FIG. 6 illustrates a system that includes gateway devices at various points along the travel path of a shipment, a tag device attached to the shipment, and a representation of the ledger collecting information from each gateway along the path of the shipment. The diagram shows multiple data interactions representing encoded keys (RKEYS) with specific entries such as JT5RD and 36JX2 of which each individual RKEY is transmitted to the tag device from a different gateway. Additionally, the figure includes visual elements like Wi-Fi signals and barcodes, indicating a complex process of encoding and location authentication within the travel path authentication solution.

FIG. 7 illustrates the travel path authentication system device network covering stages such as origin, distribution, shippers/carriers, sellers/retailers, and journey fingerprinting. The diagram shows interconnected components including various locations and transit points. Gateway devices are depicted at each stage, identified by specific device identifiers like JT5RD and 76DSK. These devices gather and transmit encoded data represented by RKEYs to the tag devices attached to each shipment. The figure demonstrates how the ledger data encrypted in the tag device will differ for each shipment at its destination based on the gateways it encountered and collected RKEYs from on its travel path.

FIG. 8 depicts an embodiment in which a device is used to scan and recognize a code on wine bottle label containing the ledger information which verifies the integrity of the travel path of the bottle.

FIG. 9 illustrates the process by which sectors of the travel path logged in the tag device ledger are compared to the master repository of RKEYs at each location within the sectors to determine whether variations in the travel path are acceptable and approved to be added to the master repository.

### DETAILED DESCRIPTION OF THE INVENTION

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

### DETAILED DESCRIPTION OF DRAWINGS

To facilitate understanding and implementation of the invention, reference signs are employed throughout the specification and drawings as follows:
1. Gateway—For contextual clarity within the invention disclosure, “gateway” pertains to a network node equipped for interfacing distinct communication networks or segments based on different protocols. Herein, it refers to the device or assembly that captures raw data from the array of sensing constituents at a location. The gateway's primary role entails collating the assorted sensory inputs, forming comprehensible datasets from these diverse streams of raw data, enabling subsequent stages of processing including encryption or encapsulation to generate unique cryptographic keys reflective of each location's distinct entirely unique features, and transmitting the cryptographic keys (RKEYs) to the tag device.
2. RKEY—The RKEY or cryptographic key is the hash code embodying the precise environmental parameters of the physical location of the gateway, collected by sensors and transmitted to the gateway before being encrypted by the gateway. Consequent to its generation, it can be applied to ascertain location authenticity efficiently and provide incorruptible positional confirmation within the operational framework of the travel path authentication system.
3. Tag—The tag device or tag is an electronic transmitter and receiver containing digital storage that attaches to, is embedded in, or otherwise is physically associated with one or more items traveling throughout the supply chain. These tag devices electronically receive RKEYs from the gateways in the sequential order of the tag's travel as part of the travel path authentication method, thereby further enhancing the granular traceability and accountability across the supply network.

The capabilities inherent in the proposed solution represent a significant advancement in combating fraud, loss, and tampering within logistical operations. It stands as both testament and bulwark to the integrity of modern supply chains.

The aforementioned components and methodologies converge into a holistic approach aimed at preserving supply chain sanctity by offering verifiable, high-fidelity logs of geographic data points.

These reference signs correspond with illustrative embodiments laid out in accompanying diagrams and serve to clarify the operational intricacies entwined with deploying and utilizing this travel path authentication solution effectively.

By creating a reliable and secure methodology for authenticating geographic locations within logistics operations, this invention undeniably advances practices by enhancing security protocols involved in the transport and delivery of goods throughout a supply chain network.

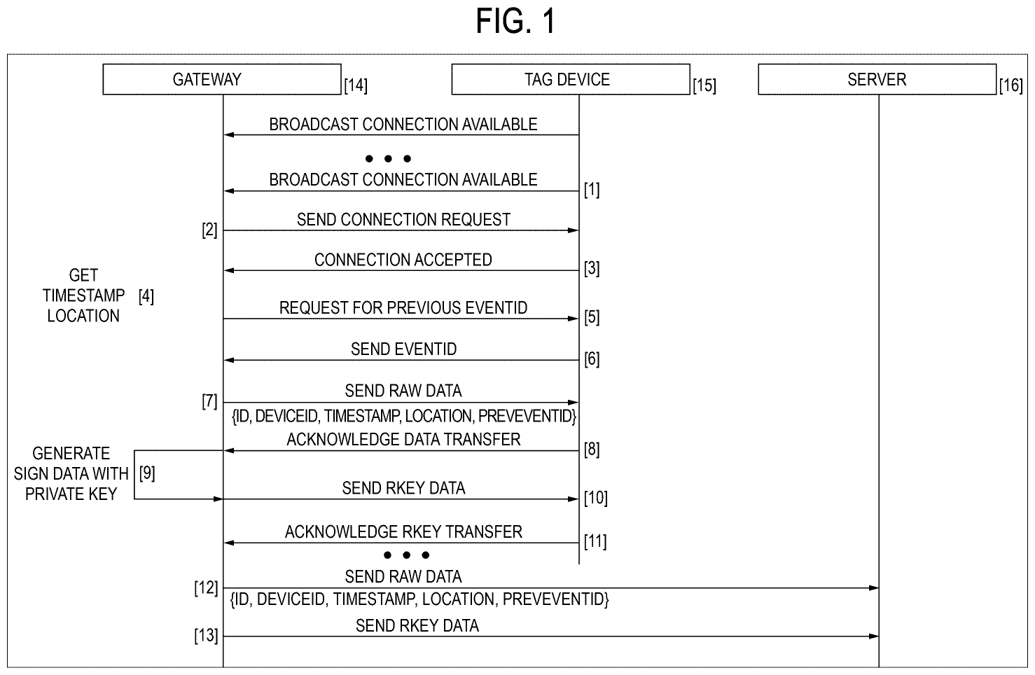

FIG. 1 illustrates system aspects of an overall travel path authentication solution according to a preferred embodiment of the present invention. Method aspects of the solution will be described below with reference to the further figures. The solution comprises a system for automatic travel path authentication which in turn comprises devices including a server 16, a tag device 15, a gateway 14, and sensing devices which send information to the gateway. The gateway contains receivers to receive information from the sensors in its vicinity, wireless transmitting and receiving functionality, a processing unit, and a memory. The memory stores a computer program being configured to be executed on the processing unit in order to cause the gateway to use the raw data received by sensors to generate a unique encrypted RKEY to be transmitted to the tag device. The tag device contains wireless transmitting and receiving functionality and memory to store a decentralized ledger of the RKEYs and other information received from the gateway. The server is as is generally understood to consist of data storage and communication functionality.

Initially, the tag device 15 constantly broadcasts connection availability 1 to the gateway 14. When a gateway comes within range of a tag device's connection request, the gateway responds with a connection request 2. Upon acceptance, the tag device completes the connection request, establishing two-way communication between the gateway and the tag device. The gateway requests the previous event ID 5 from the tag device. Subsequently, the tag device sends the event ID 6. The gateway then processes the raw data it receives from the sensors and generates the RKEY 9 for the raw data package by cryptographically signing the data package with the gateway's private key. The gateway then transmits 10 the RKEY 9 to the tag device 15, along with the device ID, timestamp, location, and previous event ID 8. The tag device 15 then transmits 11 an acknowledgement of receipt of the RKEY 9 and other data to the gateway 14. This completes the transaction between the tag device and the gateway at one location. Once the gateway has an internet connection, the gateway 14 then transmits the raw data 12 and the RKEY 13 to the server. This sequence is indicative of consistent communication for data and key exchange across the devices involved.

The first layer of sensors, both active and passive, act as a simple data gathering source, gathering primarily environmental discriminating characteristics of the physical location of the gateway and sensors. The sensors can also communicate between each other as a peer-to-peer intranet, where they can all act as a single instance if they are grouped together with a unique disposable ID. The peer-to-peer feature allows multiple sensors on the same group to share internal data, including but not limited to environmental and shipping details, documents, and certificates. The peer-to-peer is a valuable feature where during transportation not all the sensing tags as physically accessible, like crates loaded into a truck, shipping container, staked boxes, etc . . .

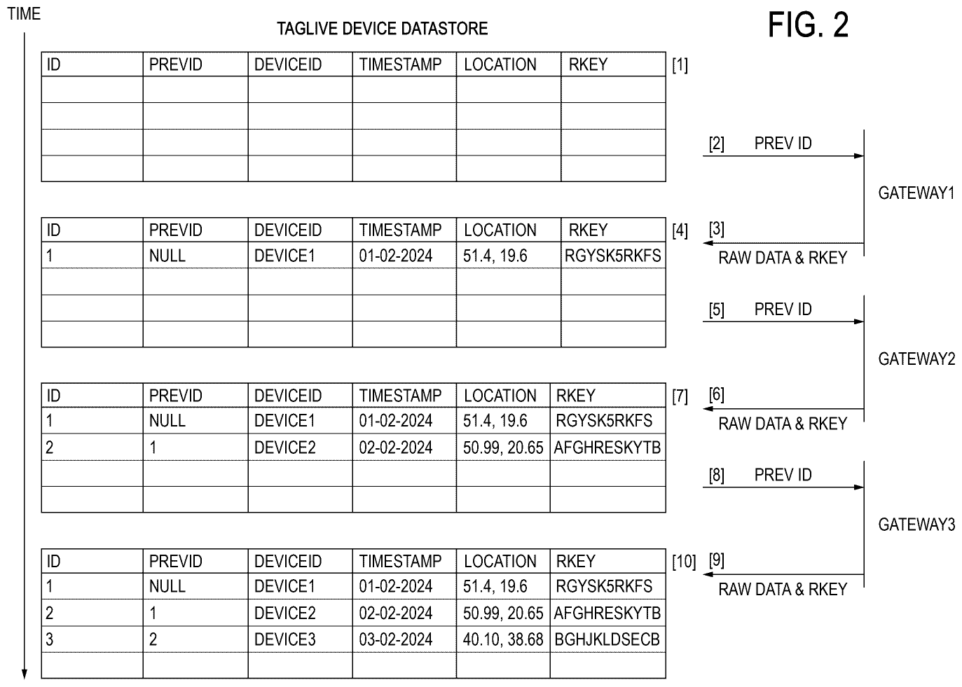

FIG. 2 illustrates how the gateway and tag devices generate a ledger as they progress through the supply chain, using the method described in FIG. 1 for each gateway-to-tag device interaction.

In this illustration, the column labeled “ID” contains sample values, with an initial value of “1”. This ID acts as a unique identifier for each gateway encountered by the tag device and the data entry received by the tag device from that gateway. In the described invention, the column labeled PREV ID refers to the preceding identification record, thus facilitating sequential tracking and validation across multiple data entries. Such a structure ensures the effective linking of data points, thereby enhancing the integrity and reliability of the authentication process.

The column labeled RKEY contains cryptographic keys generated from the spatial data gathered by sensor devices and processed by the respective gateway. These keys are central to the Automatic Location Recognition method, serving as unique identifiers that enhance the accuracy and reliability of pinpointing a location in the travel path authentication solution. Each entry within this column is an encoded representation generated through the machine-learning-based location recognition process, providing a high degree of security and integrity for the associated location data.

In the depicted figure, the column labeled LOCATION with coordinates refers to a specific section where geographic coordinates are recorded. This column includes numerical entries that represent precise points on a map, indicating the exact location of a gateway device at a particular time. Each entry corresponds further to the unique spatial-temporal data captured during the travel path authentication process, providing critical reference for the identification and verification of locations traversed within the supply chain.

The column labeled “TIMESTAMP” is utilized to store date entries corresponding to specific data events captured through the system. Each entry in this column marks a distinct temporal point, where associated data such as device identifiers (DEVCEID) and location coordinates are recorded to the tag device from the gateway alongside their respective timestamps. This temporal information is instrumental in tracking the chronological order of data transmission and ensuring accurate mapping of the entire travel path within the authentication solution.

The final column 10 with multiple RKEY entries refers to a part of the sequential data storage and transmission system depicted in the figure. This column contains different encoded cryptographic keys, known as RKEYs, that correspond to specific physical location identifiers generated by each gateway and transmitted to the tag device during the location recognition process. Each RKEY is unique and serves to securely identify and authenticate particular locations along the travel path. These encoded values ensure the integrity of the data across various gateways in the system.

As depicted in the final table of FIG. 2, the ultimate ledger reflects information transmitted to the tag device by gateway1, gateway2, and gateway3, in sequential order. At the end of the travel path, the ledgers can be authenticated on the server by using the public keys of each gateway to decrypt the chain of RKEYs on a ledger. A break in the chain of RKEYs or a mismatch between the raw data and the RKEY will indicate that the chain of custody for the tag (and associated item) has been tampered with. Gateways can read the raw data ledger at any point when connected to a tag device. The gateway and tag are logically separated but can co-exist in the same environment. Items such as documents, audio, video, applications, or any other supported format, that need to be shared are uploaded to the server for distribution to the tag devices, and a RKEY is created for said document or other file item that is shared across the network.

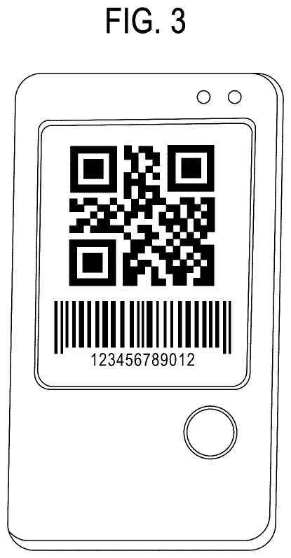

FIG. 3 illustrates one embodiment of the tag device whereby the device consists of an electronic sensor capable of interacting with a gateway and receiving an RKEY from a gateway via any available wireless methods, including but not limited to Bluetooth, secured Wi-Fi connection, or other methods known in the art. Other embodiments of the tag device can include printed electronics, embossed circuitry, 3D-printed circuitry or in-mold electronics, whereby the tag device is embedded directly onto the item instead of being a separate device attached to the item.

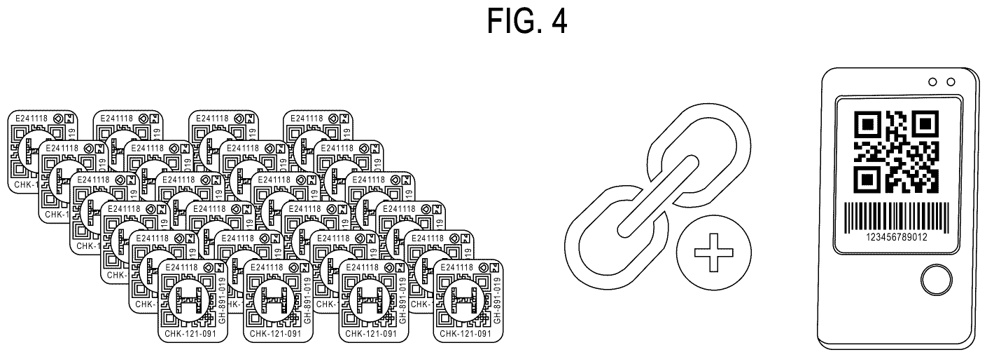

FIG. 4 illustrates an embodiment for associating the tag device to multiple items within a shipment. In this embodiment each item within a shipment is affixed with a unique identifier, which can be, but is not limited to QR codes, which are digitally linked to the tag device. This allows for the integrity of the travel path of the shipment itself to be authenticated, and also the specific inventory of the shipment, as the tag device stores the number of items in the shipment.

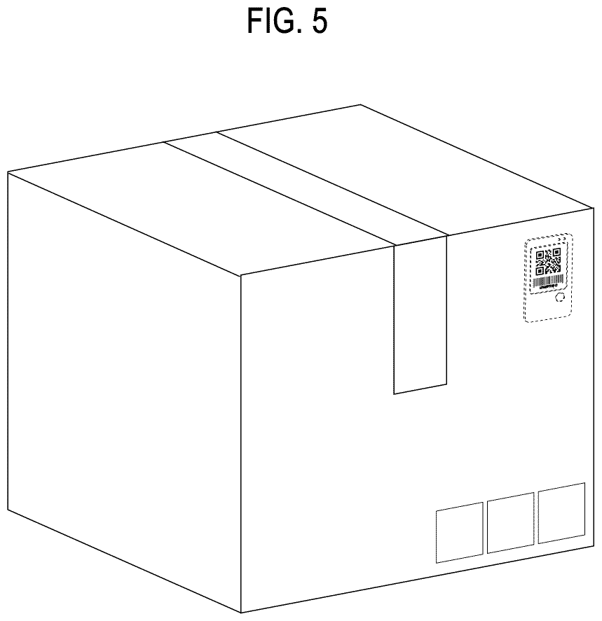

FIG. 5 illustrates one method of affixing a tag device to a shipment. Other methods can include enclosing it within the shipment, or any method for securely affixing a tag device to a shipment, including without limitation the embodiments described in FIG. 3 herein.

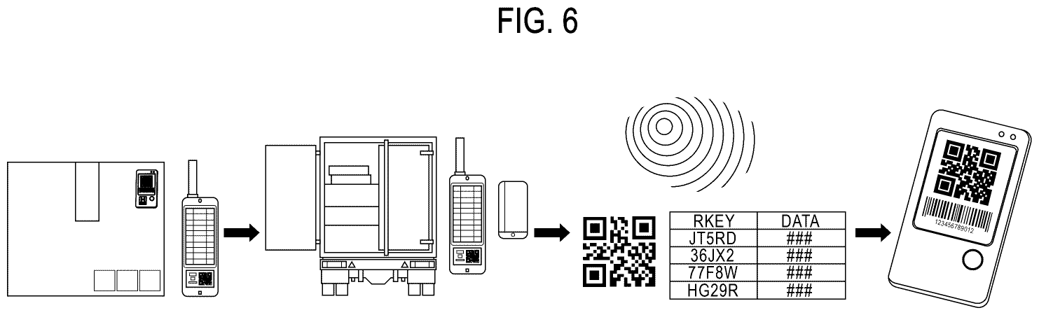

FIG. 6 refers to a preferred embodiment of the present authentication solution wherein gateways are installed at multiple locations along a supply chain, including at the original manufacturer, and in a truck used for shipment. In each location, the gateway collects information from various sensors in its vicinity, and the gateway uses the raw data collected from the sensors to generate a RKEY, which is transmitted to the tag device attached to the shipment and added in sequential order to the ledger of the tag device.

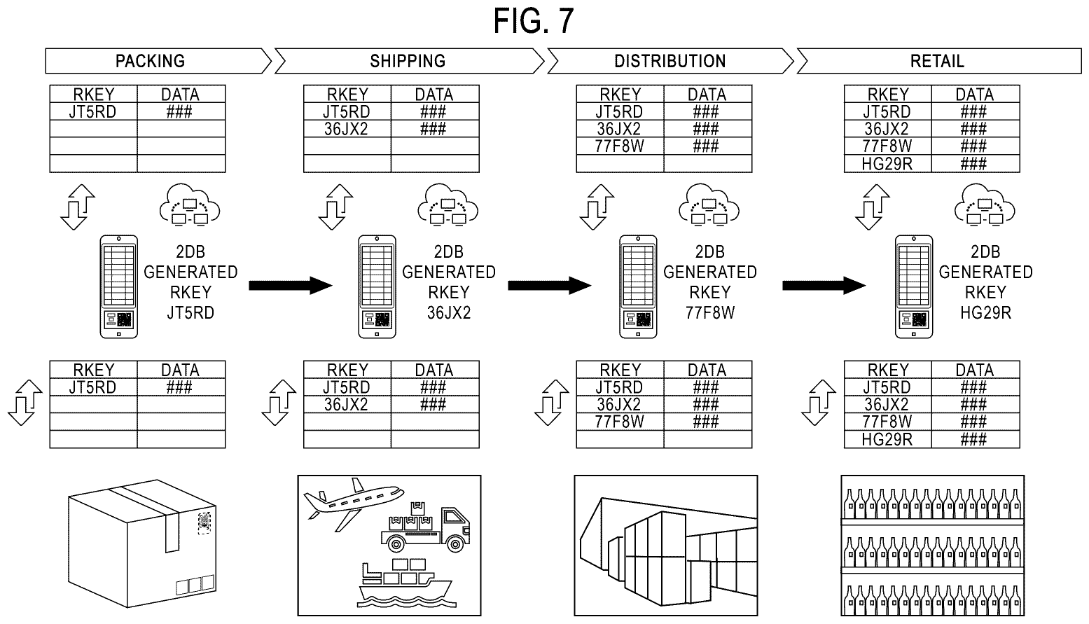

FIG. 7 further illustrates the distribution and tracking process across various stages, including origin, distribution, shippers, and retailers, using device identifiers and encoded data. At the first node of the supply chain, the original manufacturer, the gateway device at the manufacturer location transmits an RKEY to the tag device on the shipment. At each point thereafter where a gateway is located, the gateway device at that location transmits an RKEY uniquely identifying that location with a digital signature, and the RKEY is added to the ledger of the tag device. When the shipment and corresponding tag device reach the final destination, the ledger of the tag device will have recorded each unique location through which the shipment traveled in order to authenticate that the shipment has followed a verifiable path from origin to destination without relying on human input at any step.

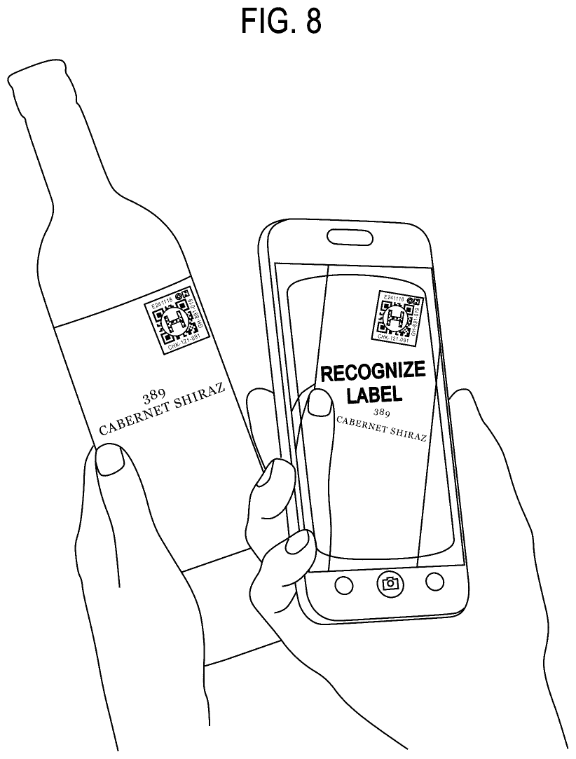

FIG. 8 illustrates the QR code on an individual item within a shipment being scanned to verify that it is indeed part of the original shipment from the point of origin and that it links with the corresponding tag device to authenticate its travel path from point of origin to destination.

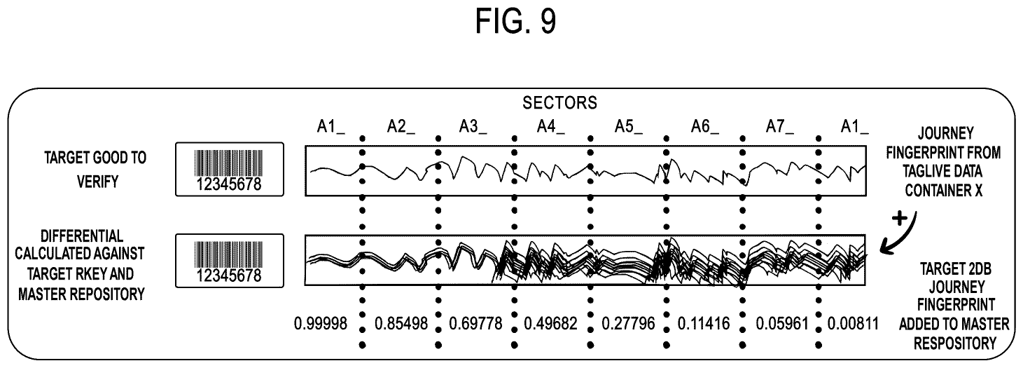

FIG. 9 illustrates a comparison of journey fingerprints in a blockchain context. It depicts a sequence of sectors labeled A1 to A7, each representing data points on the travel path of the good to be verified, barcode 12345678, contained within the shipment identified by “TAGLIVE DATA CONTAINER X”, and compares it to the sequence of entries for tag devices which have been verified to have previously followed the same path in the master repository. The figure shows differential calculations against a target RKEY (encoded data) and verification labels. When the blockchain sequence of data for TAGLIVE DATA CONTAINER X falls within a margin of acceptability as compared to the master repository of data for that same travel path, it is verified that the TAGLIVE DATA CONTAINER X's travel path is authenticated, that the item identified by barcode 12345678 was in the shipment identified by TAGLIVE DATA CONTAINER X, and the TAGLIVE DATA CONTAINER X data is added to the master repository.

This detailed description exemplifies specific aspects and operational frameworks of the present invention and should not be construed as limiting in scope. Instead, it provides guidance on implementing various features that embody the principles of this innovation. It posits that complementary arrangements and modifications can be conceived by those skilled in the relevant arts while maintaining adherence to the essence and ambit of the invention as claimed.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein. ” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 C.F.R. &sect; 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A method of authenticating a travel path using a device distributed blockchain system, the method comprising:
collecting one or more discriminating characteristics of a physical location from sensors at a physical location;
transmitting said discriminating characteristics from said sensors to a gateway;
generating physical location raw data from said one or more discriminating characteristics of said physical location at the gateway;
generating a unique cryptographic key representing said physical location raw data of said physical location;
transmitting said cryptographic key, hardware identifiers of said gateway, location information, and timestamp information from said gateway to a tag physically affixed to an object in transit;
transmitting said cryptographic key, hardware identifiers of said gateway and said physical location raw data to a server;
wherein said tag contains a sequential decentralized ledger;
wherein said sequential decentralized ledger contains at least said cryptographic key, said location information, said timestamp information, and said hardware identifiers of said gateway from which said tag received said cryptographic key;
wherein a digital twin of each said decentralized ledger is maintained on said server;
wherein said server contains said physical location raw data, said cryptographic key, said timestamp information, and said hardware identifiers of said gateway;
further comprising asynchronously updating said decentralized ledger;
wherein said cryptographic key based on said discriminating characteristics and said hardware identifiers create unique location-based fingerprints for each ledger entry, linking these ledger entries to form an immutable chain;
repeating the steps herein to create a new decentralized ledger entry for each gateway that communicates with said tag;
outputting said ledger indicating the travel path of said tag and comparing said ledger to the information contained in said server for each ledger entry.

2. The method of claim 1, wherein each tag autonomously connects with gateways to receive cryptographic keys and records information during transit of said tag.

3. The method of claim 1, further comprising storing raw data packets containing location identifiers and timestamps in a distributed ledger across tag devices.

4. The method of claim 1, further including retaining master repositories that contain digital profiles of physical locations at each gateway.

5. The method of claim 1, wherein sensing devices deployed along the supply chain synchronize time with local gateway devices for accurate event logging.

6. A distributed blockchain system for travel path authentication, comprising a network of devices configured to generate globally unique certificates based on cryptographic keys generated from environmental inputs, hardware identification information, and other inputs to gateways, wherein the devices maintain asynchronous update cycles on ledgers contained within tags.

7. The system of claim 6, wherein each certificate includes an immutable cryptographic key linked to previous events and physical locations.

8. The system of claim 6, wherein the cryptographic key is generated by digitally signing data packages with a private key of a gateway device.

9. The system of claim 6, wherein each gateway device generates a public-private key pair for data authentication and validation within the network.

10. The system of claim 6, wherein the tag device is configured to connect with gateway devices to transmit data.

11. The system of claim 6, wherein the tag device operates as a data logger with an optional e-ink display for data synchronization and collection.

12. The system of claim 6, wherein location data and timestamps are included in the data packages recorded in distributed ledgers.

13. The system of claim 6, further comprising peering capabilities allowing multiple sensing devices grouped with a unique identifier to communicate internally.

14. A computer program comprising instructions, which when executed on one or more processors of a travel path authentication device network causes the travel path authentication device network to perform the method according to claim 1.

15. A system for automatic authentication of travel path data, the system comprising:
A first device configured to carry out steps comprising:
receiving physical location raw data from sensors where said physical location raw data represents one or more discriminating characteristics of a physical location;
processing the physical location raw data by means of a machine-learning-based physical location recognition process to obtain discriminating data representing one or more virtual representations of the physical location;
generating a unique cryptographic key based on the discriminating characteristics of the physical location;
receiving information from a second device;
verifying the identity of the second device;
transmitting the cryptographic key and at least one discriminating characteristic of said physical location to the second device;
transmitting the cryptographic key and the physical location raw data to a server;
and a second device physically affixed to an object and configured to carry out steps comprising:
Sending availability notifications to said first device;
receiving said cryptographic key and discriminating characteristic information from said first device;
appending said cryptographic key and discriminating characteristic information from said first device to a digital ledger;
outputting the data from said digital ledger;
and a third device configured to carry out steps comprising:
receiving physical location raw data from said first device;
utilizing machine-learning to generate a digital profile of said physical location raw data;
decrypting said cryptographic keys contained in the ledger of said second device
compared said decrypted information from the cryptographic keys to the profiles of physical location raw data stored in said server indicating whether, according to the results of this authentication, said object reached a destination via a legitimate authorized path of travel.
